(19) United States
(12) Patent Application Publication
(10) Pub. No.: US 2017/0155981 A1
(43) Pub. Date: Jun. 1, 2017

(54) OPTICAL TRANSMISSION DEVICE AND OPTICAL TRANSMISSION SYSTEM

(71) Applicant: FUJITSU LIMITED, Kawasaki-shi (JP)

(72) Inventors: GOJI NAKAGAWA, Sagamihara (JP); Yasuhiko Aoki, Yokohama (JP); Kyosuke Sone, Kawasaki (JP); Shoichiro Oda, Fuchu (JP); Setsuo Yoshida, Inagi (JP)

(73) Assignee: FUJITSU LIMITED, Kawasaki-shi (JP)

(21) Appl. No.: 15/259,530

(22) Filed: Sep. 8, 2016

(30) Foreign Application Priority Data
Nov. 30, 2015 (JP) 2015-232622

(51) Int. Cl. H04Q 11/00; H04J 14/02

(52) U.S. Cl. CPC H04Q 11/0005; H04J 14/0212; H04Q 2011/0016; H04Q 2011/0015; H04Q 2011/0018

(57) ABSTRACT

An optical transmission device includes: a plurality of optical transceivers; a wavelength selective switch; and a controller configured to control the plurality of optical transceivers and the wavelength selective switch. Each of the optical transceivers includes a wavelength tunable light source. The controller controls a wavelength of a wavelength tunable light source of a selected optical transceiver according to a wavelength of an optical signal received by the destination remote device. The controller controls the wavelength selective switch so as to generate the WDM optical signal from a plurality of optical signals generated by the plurality of optical transceivers, and to guide the plurality of optical signals received from the plurality of remote devices to the plurality of optical transceivers according to wavelengths of the received plurality of optical signals.

### CROSS-REFERENCE TO RELATED APPLICATION

This application is based upon and claims the benefit of priority of the prior Japanese Patent Application No. 2015-232622, filed on Nov. 30, 2015, the entire contents of which are incorporated herein by reference.

### FIELD

The embodiments discussed herein are related to an optical transmission device that transmits a wavelength division multiplexed optical signal and an optical transmission system.

### BACKGROUND

In recent years, traffic in an access network that connects between a base station and a host station has been increasing with increasing mobile traffic. The host station can accommodate a plurality of base stations.

On the other hand, a PON (passive optical network) system has become widespread. The PON system is established in an ODN (optical distribution network), and can multicast a signal from a central station to a plurality of terminals. Thus, a configuration that realizes an access network for mobile traffic using an existing PON system has been proposed. Further, a configuration in which a wavelength division multiplexing (WDM) transmission is used for an access network for mobile traffic has also been proposed.

FIGS. 1A and 1B illustrate examples of a mobile access network. In the examples of FIGS. 1A and 1B, a host station 1000 includes a baseband unit (BBU) 1001 and an optical line terminal (OLT) 1002. Further, a plurality of base stations are connected to the host station 1000 through a passive splitter 1003. Each base station includes an optical network unit (ONU) and a remote radio head (RRH). A cell is formed by each base station.

The baseband unit 1001 generates a signal to be transmitted to a base station, and processes a signal received from a base station. The optical line terminal 1002 converts a signal generated by the baseband unit 1001 into an optical signal, and converts an optical signal received from a base station into an electric signal. The passive splitter 1003 distributes an optical signal generated by the optical line terminal 1002 to a plurality of base stations, and guides optical signals received from a plurality of base stations to the optical line terminal 1002.

When a WDM transmission is used for the mobile access network of FIG. 1A or 1B, the host station 1000 may generate optical signals of different wavelengths with respect to a plurality of base stations. In this case, the optical line terminal 1002 multiplexes the plurality optical signals so as to generate a WDM optical signal. The WDM optical signal is distributed by the passive splitter 1003 to each of the base stations. In other words, the same WDM optical signal is transmitted to the plurality of base stations. Each of the base stations extracts a target signal from the received WDM optical signal. Further, the plurality of base stations can transmit optical signals of different wavelength to the host station 1000.

The PON system for which a WDM technology is used is disclosed in, for example, Japanese Laid-open Patent Publication No. 2015-154399.

In the mobile access network described above, traffic in a certain area may increase. In this case, it is preferable that a plurality of base stations located in the certain area perform a coordinated multipoint (CoMP) transmission. The coordinated multipoint transmission is a technology adopted by the LTE-A (Long Term Evolution-Advanced), and a plurality of adjacent base stations transmit a signal to a terminal in a coordinated manner. Thus, the quality and/or the efficiency of a communication is improved in the cells of the plurality of base stations that perform a coordinated multipoint transmission. The shaded portion illustrated in FIG. 1A represents cells in which a coordinated multipoint transmission is performed. The area having heavy traffic may be moved. In this case, the area in which a coordinated multipoint transmission is performed is also moved, as illustrated in FIG. 1B. The base station that performs a coordinated multipoint transmission may hereinafter be referred to as a “coordination base station”.

In this case, when a WDM transmission is used for a mobile access network, the host station 1000 transmits optical signals of different wavelengths with respect to a plurality of base stations. Further, the plurality of base stations transmit the optical signals of different wavelengths to the host station 1000. Then, when the area in which a coordinated multipoint transmission is moved, the allocation of wavelengths used between the host station 1000 and a plurality of coordination base stations is changed.

In order to change the allocation of a wavelength used between the host station 1000 and a base station, a control sequence is performed between the host station 1000 and each base station. For example, when each base station includes a wavelength tunable light source and a wavelength tunable filter, the host station 1000 reports, to each coordination base station, information that specifies a transmitter wavelength and a received wavelength. At this point, a negotiation is performed between the host station 1000 and each base station as needed.

This kind of negotiations may be necessary not only in a mobile access network in which a coordinated transmission is performed, but also in an optical transmission system in which an optical transmission device is connected to a plurality of remote devices.

### SUMMARY

According to an aspect of the embodiments, an optical transmission device transmits a WDM (wavelength division multiplexed) optical signal to a plurality of remote devices via an optical splitter and receives a plurality of optical signals from the plurality of remote devices via the optical splitter. The optical transmission device includes: a plurality of optical transceivers; a wavelength selective switch; and a controller configured to control the plurality of optical transceivers and the wavelength selective switch. Each of the optical transceivers includes a wavelength tunable light source. The controller controls, according to a wavelength of an optical signal received by a destination remote device that is specified from the plurality of remote devices, a wavelength of a wavelength tunable light source of a selected optical transceiver that is selected from the plurality of optical transceivers according to the destination remote device. The controller controls the wavelength selective switch so as to generate the WDM optical signal from a plurality of optical signals of different wavelengths generated by the plurality of optical transceivers using respective wavelength tunable light sources, and to guide the plurality of optical signals received from the plurality of remote devices to the plurality of optical transceivers according to wavelengths of the received plurality of optical signals.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B illustrate examples of a mobile access network;

FIG. 2 illustrates an example of an optical transmission system;

FIG. 3 illustrates an example of a coordinated multipoint transmission;

FIG. 4 illustrates an example of an optical transmission system that realizes communications between a host station and a plurality of base stations;

FIG. 5 illustrates an example of an optical transmission system according to a first embodiment;

FIGS. 6 and 7 illustrate examples of a coordinated multipoint transmission performed in the first embodiment;

FIGS. 8-10 illustrate variations of the first embodiment;

FIG. 11 is a flowchart that illustrates an example of processing performed in the host station;

FIG. 12 illustrates an example of a failure detection function;

FIG. 13 illustrates an example of a function that superimposes a tone signal on an optical signal;

FIGS. 14A-14D illustrate examples of tone signals detected in a failure detection procedure;

FIG. 15 is a flowchart that illustrates an example of the method for detecting a failure;

FIG. 16 is illustrates a method for checking a setting operation in the host station; and

FIGS. 17A-17E illustrate examples of tone signals detected in a procedure of checking the setting operation in the host station.

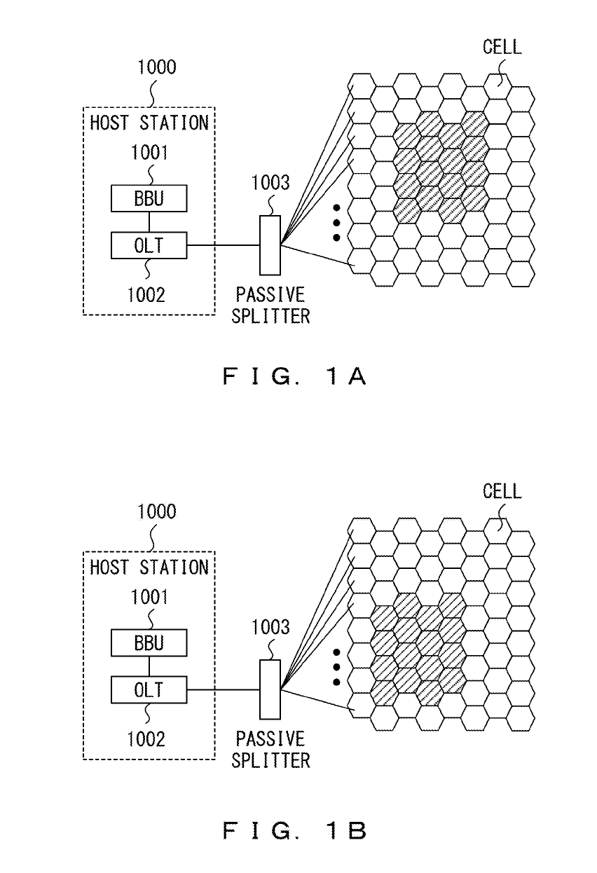

### DESCRIPTION OF EMBODIMENTS

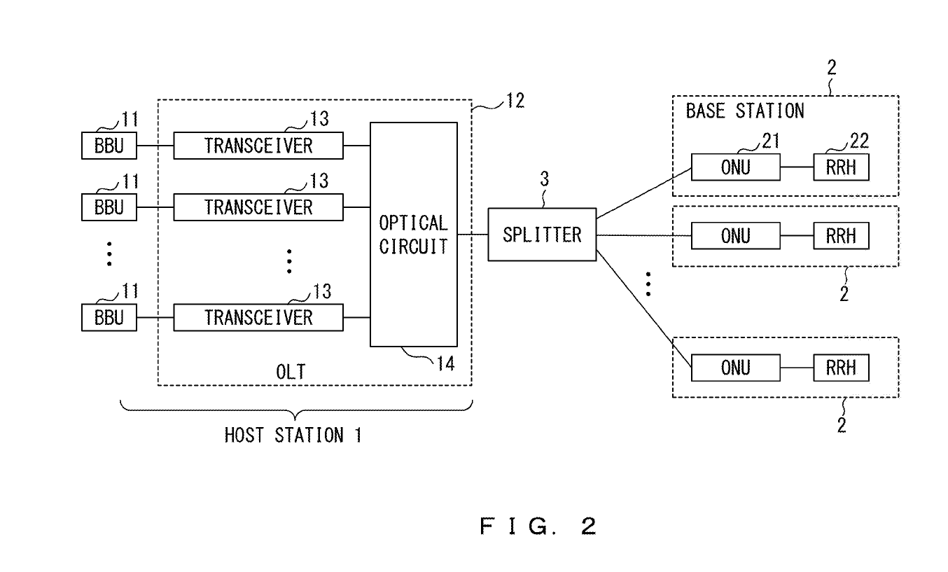

FIG. 2 illustrates an example of an optical transmission system according to embodiments of the present invention. The optical transmission system of FIG. 2 includes a host station 1, a plurality of base stations 2, and an optical splitter 3 . In this example, the optical splitter 3 is a passive device that needs no power. In other words, the host station 1, the plurality of base stations 2, and the optical splitter 3 configure a PON (passive optical network) system.

The host station 1 includes a plurality of baseband units (BBU) 11 and an optical line terminal (OLT) 12. Each baseband unit 11 generates a signal that is to be transmitted to a corresponding base station 2, and processes a signal received from the corresponding base station 2. The optical line terminal 12 includes a plurality of transceivers 13 and an optical circuit 14. In this example, one transceiver 13 is provided with respect to one baseband unit 11. Each transceiver 13 converts a signal generated from a corresponding baseband unit 11 into an optical signal, and converts an optical signal received from a corresponding base station 2 into an electric signal. Note that the transceiver 13 may perform a conversion of a format of a signal. The plurality of transceivers 13 generate optical signals of different wavelengths. The optical circuit 14 generates a WDM optical signal from a plurality of optical signals generated by the plurality of transceivers 13. Further, the optical circuit 14 guides a plurality of optical signals received from a network through the optical splitter 3 to corresponding transceivers 13 according to the wavelength.

The optical splitter 3 distributes a WDM optical signal transmitted from the host station 1 to the plurality of base stations 2. In other words, the same WDM optical signal is transmitted to the plurality of base stations 2. Further, the optical splitter 3 guides a plurality of optical signals received from the plurality of base stations 2 to the host station 1.

The base station 2 includes an optical network unit (ONU) 21 and a remote radio head (RRH) 22. The optical network unit 21 includes a transceiver, and can extract a target signal from a WDM optical signal received from the host station 1. Further, the optical network unit 21 can transmit an optical signal to the host station 1. The wavelengths of optical signals received by the respective baseband stations 2 (that is, received wavelengths) are different from one another. The wavelengths of optical signals transmitted from the respective baseband stations 2 to the host station 1 (that is, transmitter wavelengths) are also different from one another. The remote radio head 22 outputs a radio signal according to the target signal extracted by the optical network unit 21.

The host station 1 is an example of an optical transmission device. The baseband station 2 is an example of a remote device. The optical splitter 3 is an example of an optical splitter.

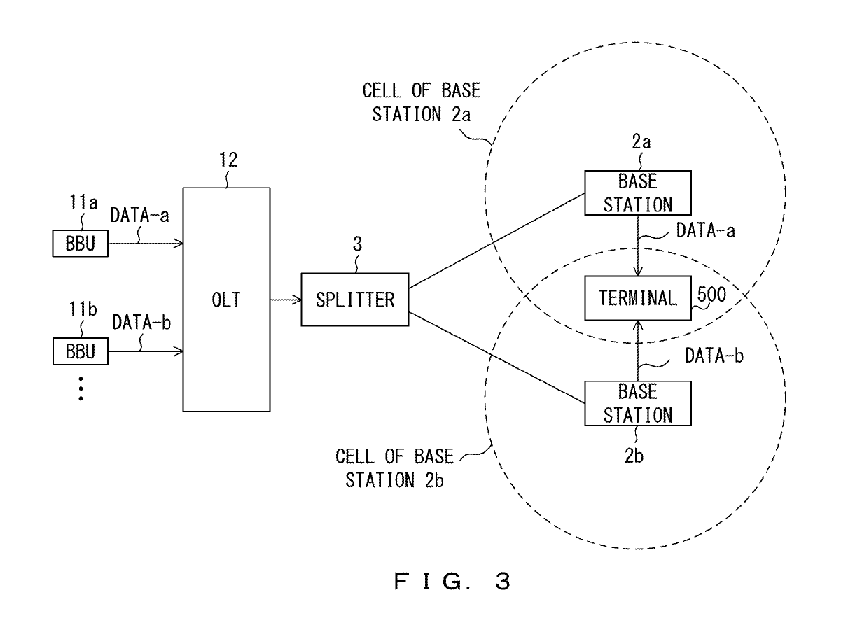

FIG. 3 illustrates an example of a coordinated multipoint transmission in the optical transmission system of FIG. 2. In the example of FIG. 3, a baseband unit 11a generates data-a that is to be transmitted to a base station 2a. A baseband unit 11b generates data-b that is to be transmitted to a base station 2b. The optical line terminal 12 generates a WDM optical signal including an optical signal that carries the data-a and an optical signal that carries the data-b. This WDM optical signal is distributed to each of the base stations (2a and 2b) through the optical splitter 3. The base station 2a extracts the data-a from the received WDM optical signal, and outputs the data-a using a radio signal. Likewise, the base station 2b extracts the data-b from the received WDM optical signal, and outputs the data-b using a radio signal. It is assumed that the base stations 2a and 2b are adjacent to each other and portions of two cells overlap.

Here, it is assumed that a terminal 500 is located in an area in which the two cells overlap. In other words, it is assumed that a radio signal transmitted from the base station 2a and a radio signal transmitted from the base station 2b arrive at the terminal 500.

In such a case, the baseband units 11a and 11b transmit the same data in a coordinated manner. In other words, it is assumed that the data-a and the data-b illustrated in FIG. 3 are the same. Next, the base stations 2a and 2b perform a data transmission in a coordinated manner. The terminal 500 receives the same data from the base stations 2a and 2b. Accordingly, the terminal 500 can recover data from a radio signal in better signal quality. Alternatively, the terminal 500 may recover data from a combined signal of the two radio signals. In either case, the communication quality between the base station 2a, 2b and the terminal 500 is improved.

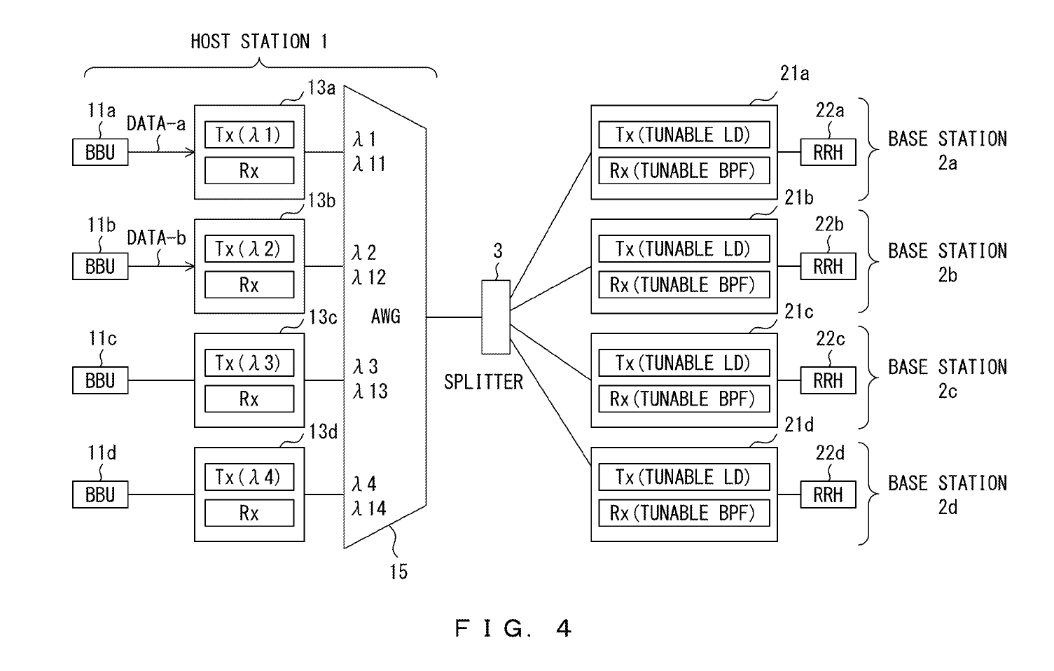

FIG. 4 illustrates an example of an optical transmission system that realizes a communication between the host station and the plurality of base stations. In the example of FIG. 4, the host station 1 includes baseband units 11a-11d, transceivers 13a-13d, and an AWG (arrayed waveguide gating) 15. The AWG 15 is an example of the optical circuit 14 of FIG. 2. A transmitter Tx of each of the transceivers 13a-13d transmits an optical signal using a wavelength-fixed light source. In this example, the wavelengths of optical signals transmitted from the transceivers 13a-13d are λ1-λ4, respectively. The AWG 15 combines optical signals output from the transceivers 13a-13d so as to generate a WDM optical signal. Further, the AWG 15 separates, for each wavelength, a plurality of optical signals received from a network through the optical splitter 3, and guides them to the corresponding transceivers 13a-13d, respectively. A specified wavelength is assigned to each optical port of the AWG 15. For example, an optical port that is connected to the transceiver 13a is designed to receive light of the wavelength λ1 and to output light of the wavelength λ11.

The base stations 2a-2d include optical network units (ONU) 21a-21d, respectively. A transmitter Tx of each of the optical network units 21a-21d can transmit an optical signal to the host station 1 using a wavelength tunable light source. A transmitter wavelength of each of the optical network units 21a-21d is specified by, for example, the host station 1. Further, a receiver Rx of each of the optical network units 21a-21d can extract an optical signal of a target wavelength from a received WDM optical signal using a wavelength tunable BPF (band pass filter). A received wavelength of each of the optical network units 21a-21d is also specified by, for example, the host station 1.

It is assumed that a coordinated multipoint transmission of the base stations 2a and 2b is performed in the optical transmission system. Further, in order to perform a coordinated multipoint transmission, the baseband unit 11a transmits the data-a to the base station 2a, and the baseband unit 11b transmits the data-b to the base station 2b.

In this case, the optical network unit 21a of the base station 2a is set up such that it communicates with the transceiver 13a. In other words, the received wavelength of the receiver Rx of the optical network unit 21a is set to λ1. This permits the base station 2a to extract, from a received WDM optical signal, the data-a transmitted from the transceiver 13a. Further, the transmitter wavelength of the transmitter Tx of the optical network unit 21a is set to λ11. As a result, an optical signal transmitted from the base station 2a is guided by the AWG 15 to the transceiver 13a. Likewise, the optical network unit 21b of the base station 2b is set up such that it communicates with the transceiver 13b. In other words, the received wavelength of the optical network unit 21b is set to λ2. This permits the base station 2b to extract, from a received WDM optical signal, the data-b transmitted from the transceiver 13b. Further, the transmitter wavelength of the optical network unit 21b is set to λ12. As a result, an optical signal transmitted from the base station 2b is guided by the AWG 15 to the transceiver 13b.

It is assumed that, after that, the communication state is changed from a state in which the coordinated multipoint transmission between the base stations 2a and 2b is performed to a state in which a coordinated multipoint transmission between the base stations 2c and 2d is performed. In this case, the host station 1 changes the settings of the optical network units 21c and 21d such that a communication is performed between the transceiver 13a, 13b and the optical network unit 21c, 21d. Specifically, the optical network unit 21c of the base station 2c is set up such that it communicates with the transceiver 13a. In other words, the received wavelength of the optical network unit 21c is set to λ1. Further, the transmitter wavelength of the optical network unit 21c is set to λ11. Likewise, the optical network unit 21d of the base station 2d is set up such that it communicates with the transceiver 13b. In other words, the received wavelength of the optical network unit 21d is set to λ2. Further, the transmitter wavelength of the optical network unit 21d is set to λ12.

As described above, in the configuration illustrated in FIG. 4, in order to change the base stations which perform a coordinated multipoint transmission, a control sequence is performed between the host station 1 and corresponding base stations. In the example described above, the host station 1 reports, to each of the base stations 2c and 2d, wavelength information that specifies a transmitter wavelength and a received wavelength, and each of the base stations 2c and 2d changes the settings of the wavelength tunable light source and the wavelength tunable BPF according to the wavelength information provided by the host station 1. In addition, the host station 1 needs to instruct each of the base stations 2a and 2b to change the transmitter wavelength and the received wavelength.

However, it is preferable that a change in a base station that performs a coordinated multipoint transmission be realized without performing a control sequence between the host station and a corresponding base station. Thus, in the following descriptions, a configuration is described that makes it possible to change the base station which performs a coordinated multipoint transmission by performing a control in a host station.

### First Embodiment

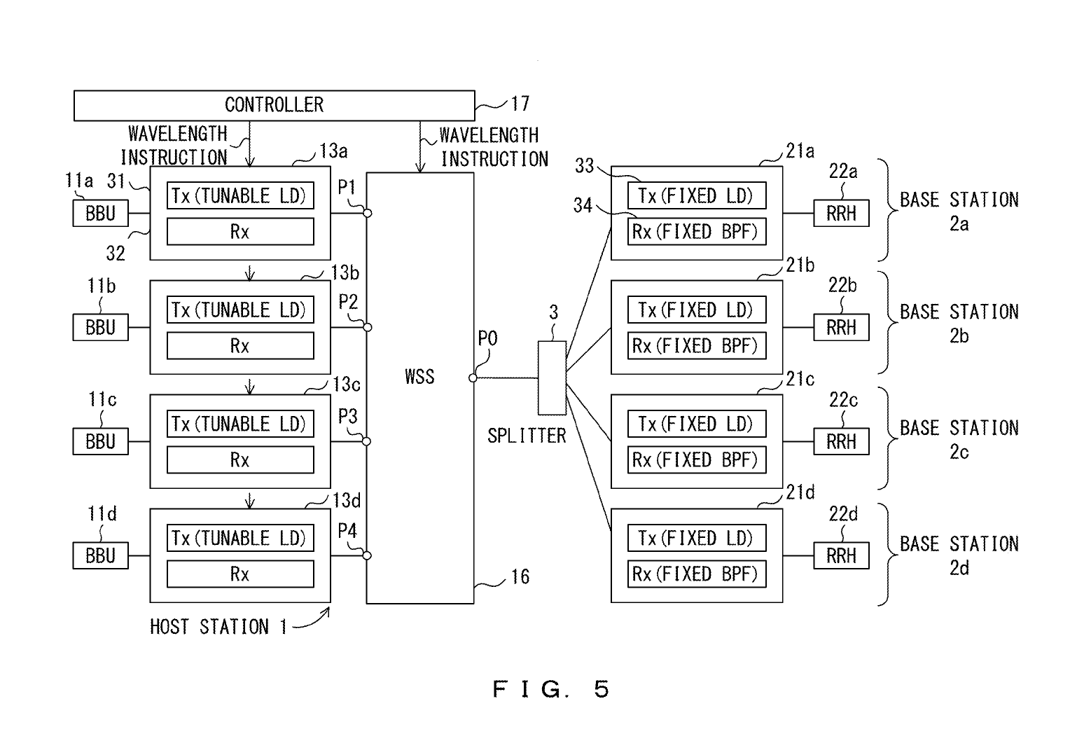

FIG. 5 illustrates an example of an optical transmission system according to a first embodiment. In the example of FIG. 5, the host station 1 includes the baseband units 11a-11d, the transceivers 13a-13d, a wavelength selective switch (WSS) 16, and a controller 17. Note that the wavelength selective switch 16 is an example of the optical circuit 14 of FIG. 2. The transceivers 13a-13d and the wavelength selective switch 16 are implemented in the optical line terminal (OLT) 12.

In the first embodiment, a transmitter (Tx) 31 of each of the transceivers 13a-13d can transmit an optical signal using a wavelength tunable light source. The wavelengths of the wavelength tunable light sources of the transceivers 13a-13d are individually controlled by the controller 17. In other words, the wavelengths of optical signals transmitted by the transceivers 13a-13d are individually controlled by the controller 17. Further, each of the transceivers 13a-13d receives an optical signal guided from the wavelength selective switch 16.

In this example, the wavelength tunable light source of the transmitter 31 is driven by a data signal provided by a corresponding baseband unit 11. In other words, the transmitter 31 can generate a modulated optical signal by direct modulation. The optical signal generated by the transmitter 31 is guided to the wavelength selective switch 16. A receiver (Rx) 32 converts the optical signal guided by the wavelength selective switch 16 into an electric signal, and demodulates the electric signal to recover data.

In this example, each transceiver 13 (13a-13d) and the wavelength selective switch 16 are optically connected to each other by one optical fiber. In other words, an optical signal is transmitted in both directions through the one optical fiber. Here, the wavelength of an optical signal guided from the transceiver 13 to the wavelength selective switch 16, and the wavelength of an optical signal guided from the wavelength selective switch 16 to the transceiver 13 are different from each other. The transmitter 31 and the receiver 32 may be optically coupled to the wavelength selective switch 16 through an optical coupler.

The wavelength selective switch 16 includes an optical port P0 through which it is connected to a network, and optical ports P1-P4 through which it is respectively connected to the transceivers 13a-13d included in the host station 1. The wavelength selective switch 16 is able to individually control, according to a wavelength instruction given by the controller 17, the wavelengths received through the optical ports P1-P4 and the wavelengths output through the optical ports P1-P4. Further, the wavelength selective switch 16 is able to multiplex optical signals received through the optical ports P1-P4, so as to generate a WDM optical signal. This WDM optical signal is output to the network through the optical port P0. On the other hand, a plurality of optical signals input to the wavelength selective switch 16 through the optical port P0 are respectively output via the optical ports P1-P4.

The base stations 2a-2d include the optical network units 21a-21d, respectively. However, in the first embodiment, a transmitter (Tx) 33 of each of the optical network units 21a-21d transmits an optical signal to the host station 1 using a wavelength-fixed light source. Here, the transmitter wavelength of each of the optical network units 21a-21d is fixed in advance. Further, a receiver (Rx) 34 of each of the optical network units 21a-21d extracts an optical signal of a target wavelength from a received WDM optical signal using a wavelength-fixed bandpass filter.

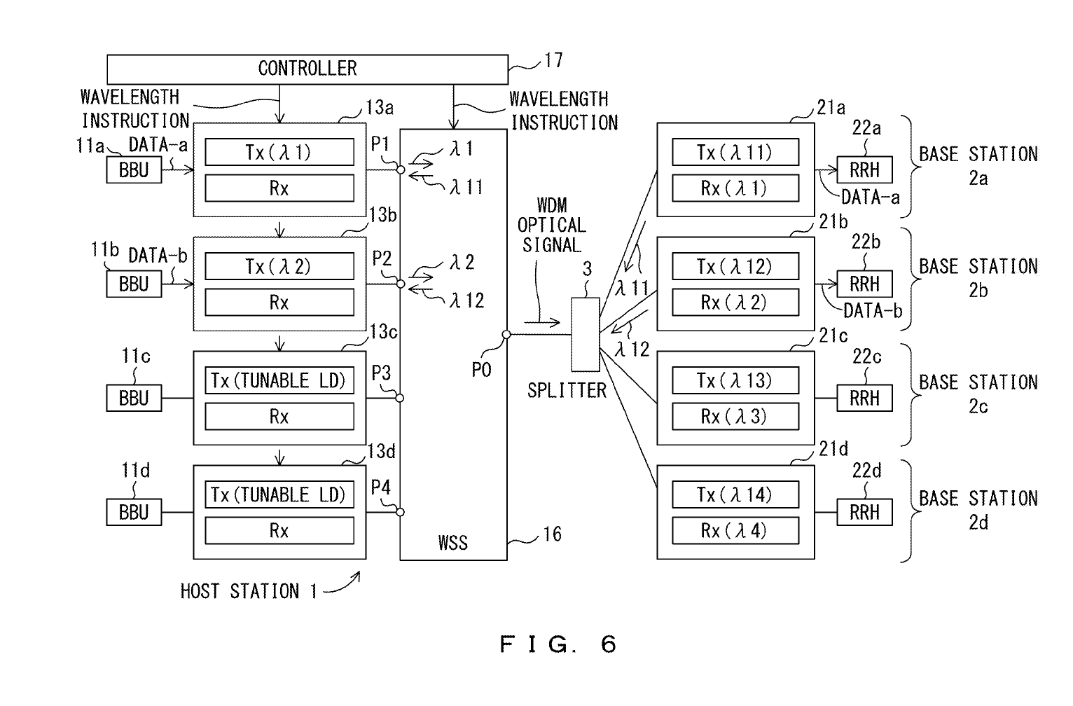

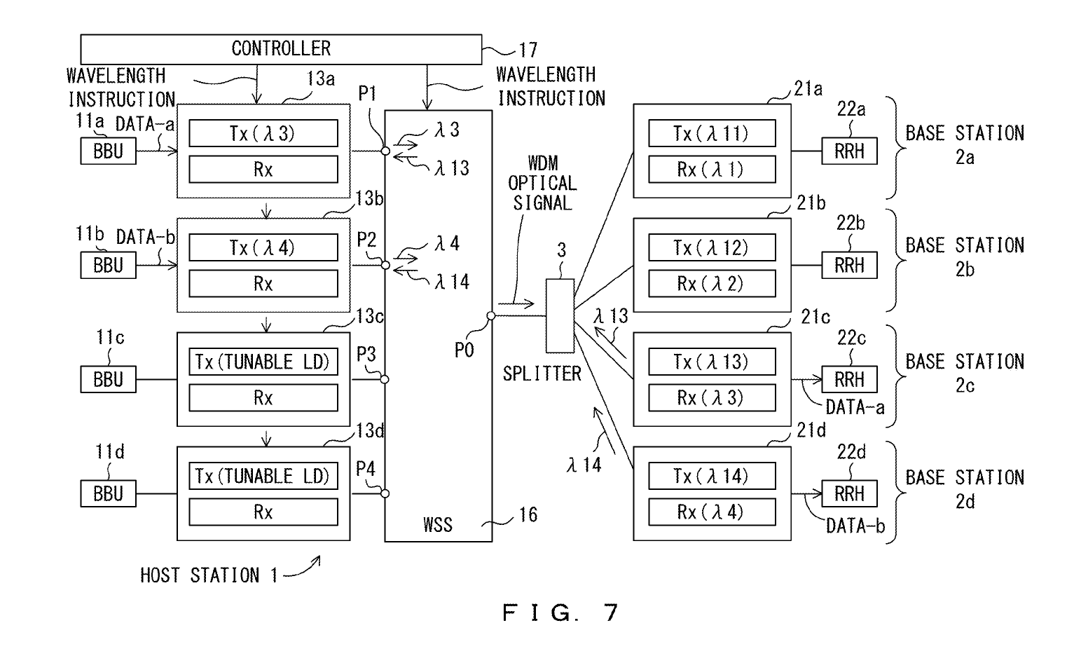

FIGS. 6 and 7 illustrate examples of a coordinated multipoint transmission performed in the optical transmission system according to the first embodiment. In the examples of FIGS. 6 and 7, the transmitter wavelengths of the transmitters 33 of the base stations 2a, 2b, 2c, and 2d are λ11, λ12, λ13, and λ14, respectively. Further, the received wavelengths of the receivers 34 of the base stations 2a, 2b, 2c, and 2d are λ1, λ2, λ3, and λ4, respectively. Data for a coordinated multipoint transmission (the data-a and the data-b) is generated by the baseband unit 11a and 11b.

In order to realize a coordinated multipoint transmission between the base stations 2a and 2b, the controller 17 controls the transceivers 13a and 13b and the wavelength selective switch 16 using wavelength instructions, such that a communication is performed between the baseband unit 11a, 11b and the base station 2a, 2b. The base station 2a receives an optical signal of the wavelength λ1. Thus, the controller 17 controls the transmitter wavelength of the transceiver 13a at λ1, and controls the received wavelength at the optical port P1 of the wavelength selective switch 16 at λ1, such that an optical signal transmitted from the transceiver 13a is received by the optical network unit 21a of the base station 2a. Further, the base station 2a transmits an optical signal of the wavelength λ11. Thus, the controller 17 controls the output wavelength at the optical port P1 of the wavelength selective switch 16 at λ11, such that an optical signal transmitted from the base station 2a is guided to the transceiver 13a. Likewise, the base station 2b receives an optical signal of the wavelength λ2. Thus, the controller 17 controls the transmitter wavelength of the transceiver 13b at λ2, and controls the received wavelength at the optical port P2 of the wavelength selective switch 16 at λ2, such that an optical signal transmitted from the transceiver 13b is received by the optical network unit 21b of the base station 2b. Further, the base station 2b transmits an optical signal of the wavelength λ12. Thus, the controller 17 controls the output wavelength at the optical port P2 of the wavelength selective switch 16 at λ12, such that an optical signal transmitted from the base station 2b is guided to the transceiver 13b.

When the configuration illustrated in FIG. 6 is completed, the following coordinated multipoint transmission is realized. The optical signal of a wavelength λx may hereinafter be referred to as an “optical signal λx”.

The transceiver 13a generates an optical signal λ1 that carries the data-a. The transceiver 13b generates an optical signal λ2 that carries the data-b. The wavelength selective switch 16 generates a WDM optical signal that includes the optical signal λ1 and the optical signal λ2. This WDM optical signal is distributed by the optical splitter 3 to the base stations 2a-2d.

The received wavelength of the base station 2a is λ1. Thus, the base station 2a extracts the optical signal λ1 from the received WDM optical signal so as to recover the data-a. The received wavelength of the base station 2b is λ2. Thus, the base station 2b extracts the optical signal λ2 from the received WDM optical signal so as to recover the data-b. Then, the base stations 2a and 2b perform a coordinated multipoint transmission using the recovered data.

The base station 2a transmits an optical signal λ11, and the base station 2b transmits an optical signal λ12. These optical signals are guided to the optical port P0 of the wavelength selective switch 16 through the optical splitter 3. At this point, the output wavelength at the optical port P1 of the wavelength selective switch 16 is set to λ11. Thus, the wavelength selective switch 16 selects the optical signal λ11 from among a plurality of optical signals input through the optical port P0, and outputs the selected optical signal through the optical port P1. As a result, the optical signal λ11 transmitted from the base station 2a is guided to the transceiver 13a. Likewise, the output wavelength at the optical port P2 of the wavelength selective switch 16 is set to λ12. Thus, the wavelength selective switch 16 selects the optical signal λ12 from among the plurality of optical signals input through the optical port P0, and outputs the selected optical signal through the optical port P2. As a result, the optical signal λ12 transmitted from the base station 2b is guided to the transceiver 13b.

It is assumed that, after that, the communication state is changed from a state in which the coordinated multipoint transmission between the base stations 2a and 2b is performed to a state in which a coordinated multipoint transmission between the base stations 2c and 2d is performed. In this case, as illustrated in FIG. 7, the controller 17 controls the transceivers 13a and 13b and the wavelength selective switch 16, such that a communication is performed between the baseband unit 11a, 11b and the base station 2c, 2d.

The base station 2c receives an optical signal of the wavelength λ3. Thus, the controller 17 controls the transmitter wavelength of the transceiver 13c at λ3, and controls the received wavelength at the optical port P1 of the wavelength selective switch 16 at λ3, such that an optical signal transmitted from the transceiver 13a is received by the optical network unit 21c of the base station 2c. Further, the base station 2c transmits an optical signal of the wavelength λ13. Thus, the controller 17 controls the output wavelength at the optical port P1 of the wavelength selective switch 16 at λ13, such that an optical signal transmitted from the base station 2c is guided to the transceiver 13a. Likewise, the base station 2d receives an optical signal of the wavelength λ4. Thus, the controller 17 controls the transmitter wavelength of the transceiver 13b at λ4, and controls the received wavelength at the optical port P2 of the wavelength selective switch 16 at λ4, such that an optical signal transmitted from the transceiver 13b is received by the optical network unit 21d of the base station 2d. Further, the base station 2d transmits an optical signal of the wavelength λ14. Thus, the controller 17 controls the output wavelength at the optical port P2 of the wavelength selective switch 16 at λ14, such that an optical signal transmitted from the base station 2d is guided to the transceiver 13b.

When the configuration illustrated in FIG. 7 is completed, the following coordinated multipoint transmission is realized. In other words, the transceiver 13a generates an optical signal λ3 that carries the data-a. The transceiver 13b generates an optical signal λ4 that carries the data-b. The wavelength selective switch 16 generates a WDM optical signal that includes the optical signal λ3 and the optical signal λ4. This WDM optical signal is distributed by the optical splitter 3 to the base stations 2a-2d.

The received wavelength of the base station 2c is λ3. Thus, the base station 2c extracts the optical signal λ3 from the received WDM optical signal so as to recover the data-a. The received wavelength of the base station 2d is λ4. Thus, the base station 2d extracts the optical signal λ4 from the received WDM optical signal so as to recover the data-b. Then, the base stations 2c and 2d perform a coordinated multipoint transmission using the recovered data.

The base station 2c transmits an optical signal λ13, and the base station 2d transmits an optical signal λ14. These optical signals are guided to the optical port P0 of the wavelength selective switch 16 through the optical splitter 3. At this point, the output wavelength at the optical port P1 of the wavelength selective switch 16 is set to λ13. Thus, the wavelength selective switch 16 selects the optical signal λ13 from among a plurality of optical signals input through the optical port P0, and outputs the selected optical signal through the optical port P1. As a result, the optical signal λ13 transmitted from the base station 2c is guided to the transceiver 13a. Likewise, the output wavelength at the optical port P2 of the wavelength selective switch 16 is set to λ14. Thus, the wavelength selective switch 16 selects the optical signal λ14 from among the plurality of optical signals input through the optical port P0, and outputs the selected optical signal through the optical port P2. As a result, the optical signal λ14 transmitted from the base station 2d is guided to the transceiver 13b.

As described above, in the optical transmission system according to the first embodiment, it is possible to change the base station which performs a coordinated multipoint transmission by changing the settings of the transceivers 13a-13d and the wavelength selective switch 16 in the host station 1. Thus, compared to the case of the configuration illustrated in FIG. 4, the time needed for an operation to change the base station which performs a coordinated multipoint transmission is shorter and the operation is more reliable in the first embodiment.

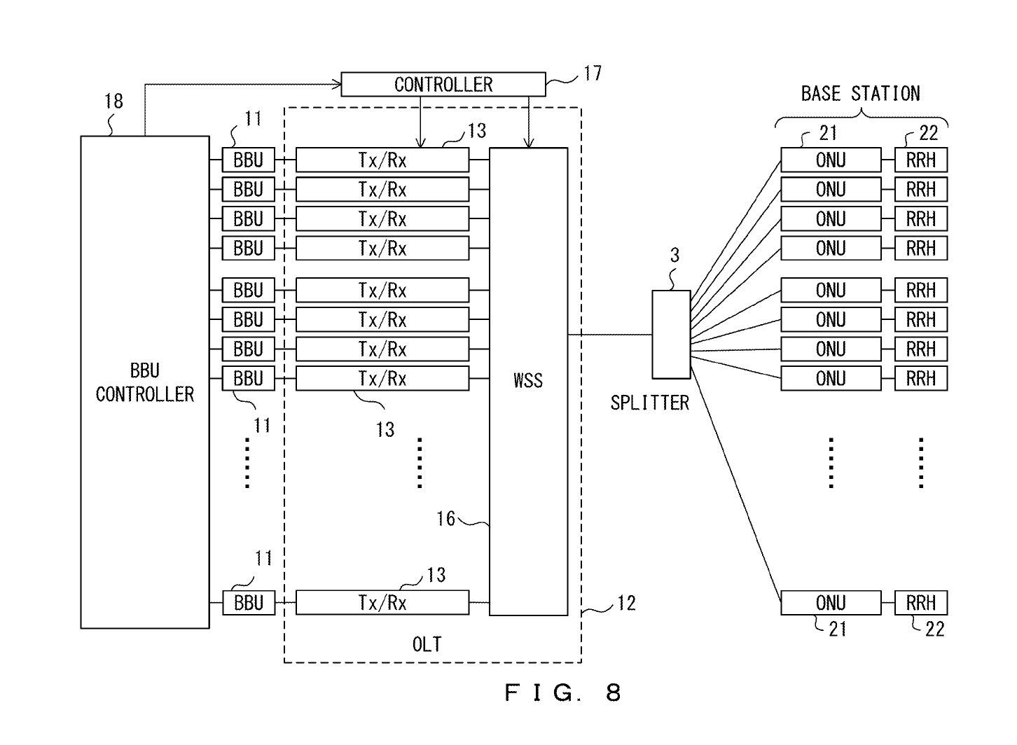

FIGS. 8-10 illustrate variations of the configuration of the optical transmission system according to the first embodiment. In FIGS. 8 to 10, one optical network unit (ONU) 21 and one remote radio head (RRH) 22 configures abase station. Further, a host station includes a plurality of baseband units (BBU) 11, the optical line terminal (OLT) 12, the controller 17, and a BBU controller 18.

The optical line terminal 12 includes a plurality of transceivers 13 and the wavelength selective switch 16. As described above, the controller 17 controls the plurality of transceivers 13 and the wavelength selective switch 16. The BBU controller 18 controls the plurality of baseband units 11 when a coordinated multipoint transmission between base stations is performed. For example, when a plurality of base stations that perform a coordinated operation are specified, the BBU controller 18 selects a plurality of baseband units 11 that correspond to the specified plurality of base stations. Then, the BBU controller 18 instructs the selected baseband units 11 to generate data for a coordinated multipoint transmission. Further, the BBU controller 18 reports, to the controller 17, information that identifies the selected baseband unit 11. The controller 17 controls the transceivers 13 and the optical ports of the wavelength selective switch that correspond to the selected baseband unit 11 in accordance with the specified base stations that perform a coordinated operation.

In the configuration illustrated in FIG. 8, the optical line terminal 12 includes a plurality of transceivers 13 and one wavelength selective switch 16. In other words, all of the transceivers 13 are optically connected to the wavelength selective switch 16. The wavelength selective switch 16 is optically connected to a plurality of base stations 2 through the optical splitter 3.

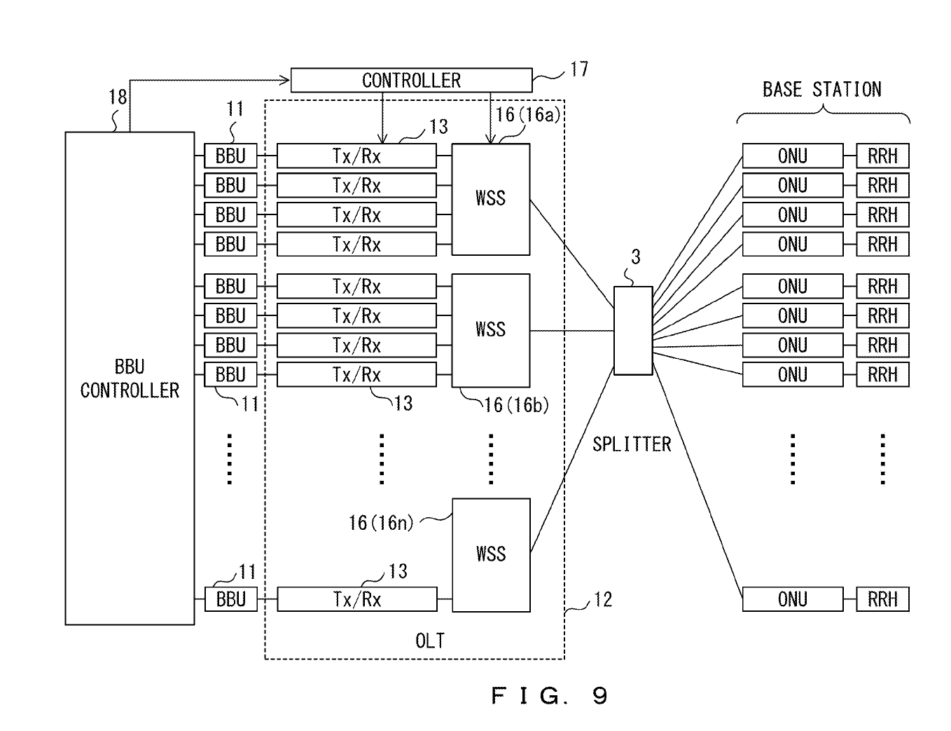

In the configuration illustrated in FIG. 9, the optical line terminal 12 includes a plurality of wavelength selective switches 16 (16a-16n). A plurality of transceivers are connected to each of the plurality of wavelength selective switches 16a-16n. In this example, one baseband unit 11 is connected to one transceiver 13. In other words, a plurality of baseband units 11 are provided for each of the plurality of wavelength selective switches 16a-16n.

When a coordinated multipoint transmission is performed in the optical transmission system illustrated in FIG. 9, the BBU controller 18 selects a plurality of baseband units 11 to be used for a coordinated multipoint transmission. In this case, the BBU controller 18 selects the plurality of baseband units 11 used for a coordinated multipoint transmission from among a plurality of baseband units 11 provided for a certain wavelength selective switch. For example, a plurality of baseband units 11 used for a coordinated multipoint transmission are selected from among four baseband units 11 provided for the wavelength selective switch 16a. In this case, a plurality of transceivers 13 used for a coordinated multipoint transmission are connected to the same wavelength selective switch.

As described above, when a plurality of transceivers 13 used for a coordinated multipoint transmission are connected to the same wavelength selective switch 16, the control time needed for changing the base station which performs a coordinated multipoint transmission is shorter. In other words, when the base station which performs a coordinated multipoint transmission is changed, the setting of the wavelength selective switch 16 is changed, as described with reference to FIGS. 6 and 7. In this case, the setting of the wavelength selective switch 16 is changed according to a wavelength instruction given by the controller 17. Thus, compared with the configuration in which wavelength instructions are given to a plurality of wavelength selective switches to change the setting of each of the switches, the control time is shorter in the configuration in which a wavelength instruction is given to one wavelength selective switch to change the setting of the switch. Further, a transmission delay is smaller in the configuration in which a plurality of transceivers 13 used for a coordinated multipoint transmission are connected to the same wavelength selective switch 16.

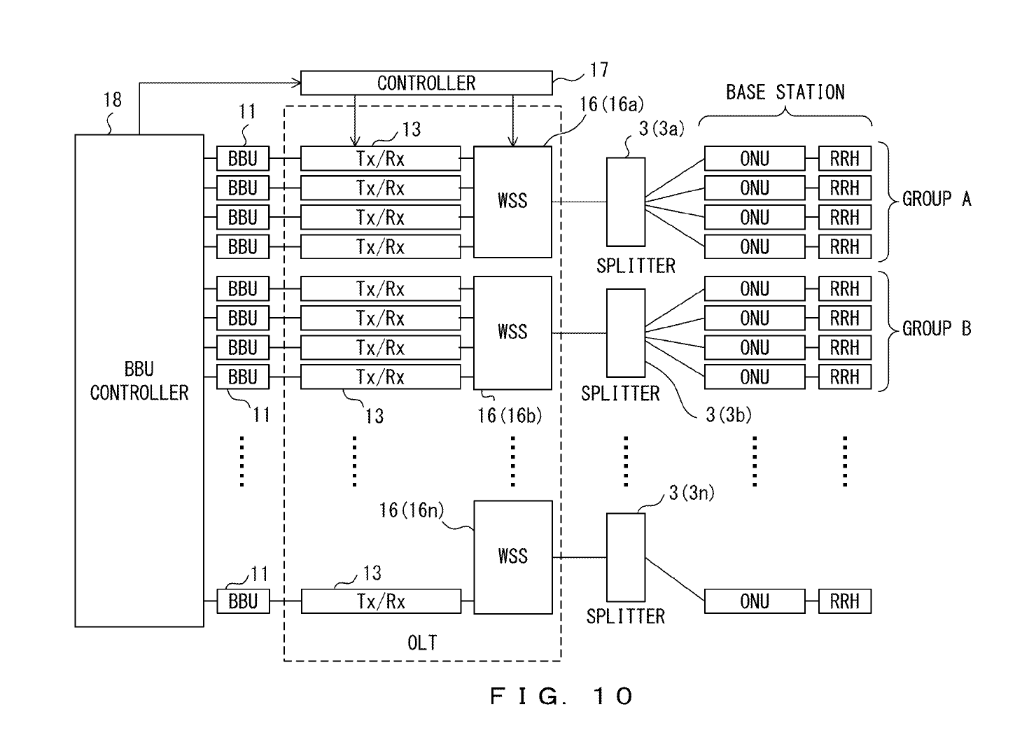

The configuration of the optical line terminal 12 is substantially the same in FIGS. 9 and 10. However, in the configuration illustrated in FIG. 10, each wavelength selective switch 16 (16a-16n) is connected to a corresponding optical splitter 3 (3a-3n).

In the configuration illustrated in FIG. 10, base stations are grouped for each wavelength selective switch (or for each optical splitter) . Thus, when the communication state is changed from a state in which a coordinated multipoint transmission is performed in a certain base station group to a state in which a coordinated multipoint transmission is performed in another base station group, the baseband unit 11, the transceiver 13, and the wavelength selective switch 16 which are used for a coordinated multipoint transmission are changed. For example, when a coordinated multipoint transmission is performed in a group A, the wavelength selective switch 16a, and baseband units 11 and transceivers 13 that are connected to the wavelength selective switch 16a are used for a coordinated multipoint transmission. When a coordinated multipoint transmission is performed in a group B, the wavelength selective switch 16b, and baseband units 11 and transceivers 13 that are connected to the wavelength selective switch 16b are used for a coordinated multipoint transmission.

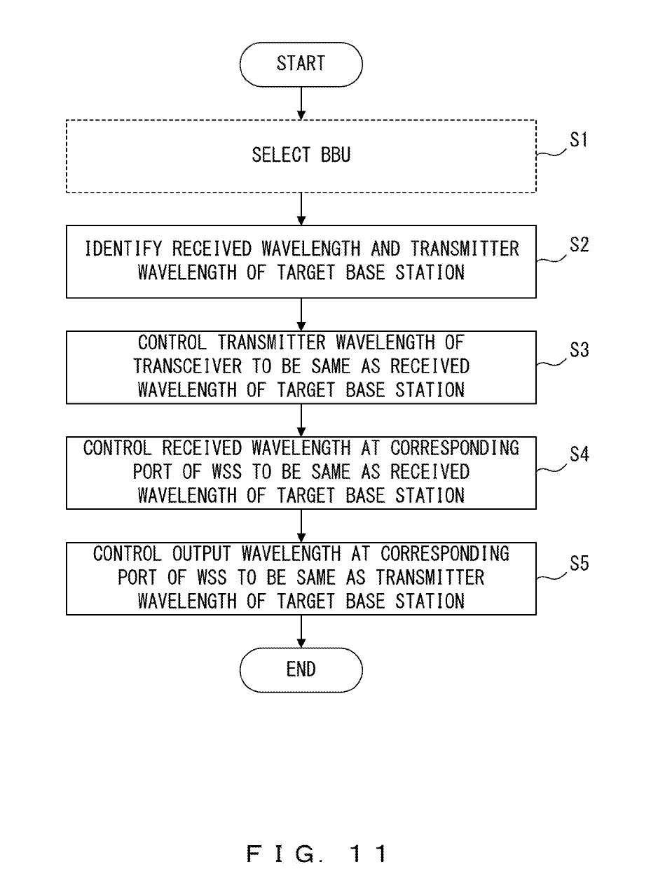

FIG. 11 is a flowchart that illustrates an example of processing performed in the host station 1. The processing of this flowchart is performed when the host station 1 is instructed to start a coordinated multipoint transmission or to change the base station which performs a coordinated multipoint transmission. The instruction includes information that identifies the base station which performs a coordinated multipoint transmission. The base station which performs a coordinated multipoint transmission may hereinafter be referred to as a “target base station”.

In S1, the BBU controller 18 selects a baseband unit to be used for performing a coordinated multipoint transmission. For example, when the host station 1 is instructed to start performing a coordinated multipoint transmission, the BBU controller 18 selects a baseband unit that operates for a target base station. Here, the number of baseband units to be selected is the same as the number of target base stations. When the baseband unit that operates for a target base station has been already selected, S1 is skipped. The baseband unit selected in S1 (or the baseband unit that has been selected previously) may hereinafter be referred to a “coordinated multipoint transmission (CoMP) baseband unit”.

In S2, the controller 17 identifies a received wavelength and a transmitter wavelength of each target base station. The received wavelength of a target base station corresponds to a transmission wavelength of a bandpass filter that is included in a receiver 34 of an optical network unit 21 of the target base station. The transmitter wavelength of a target base station corresponds to an oscillation wavelength of a wavelength-fixed light source that is included in a transmitter 33 of the optical network unit 21 of the target base station. It is assumed that management information that indicates the received wavelength and the transmitter wavelength of each of the base stations has been prepared and stored in advance in a memory in the host station 1.

In S3, the controller 17 controls the oscillation wavelength of a wavelength tunable light source of a transceiver 13 that corresponds to the CoMP transmission baseband unit such that the transmitter wavelength of the transceiver 13 matches the received wavelength of the target base station. In S4, the controller 17 controls the wavelength selective switch 16 such that the received wavelength at an optical port connected to the CoMP transmission baseband unit matches the received wavelength of the target base station. In S5, the controller 17 controls the wavelength selective switch 16 such that the output wavelength at the optical port connected to the CoMP transmission baseband unit matches the transmitter wavelength of the target base station.

The controller 17 and the BBU controller 18 are realized by, for example, a processor system that performs a given program. In this case, the processor system includes a processor element and a memory. The memory stores information for managing a transmitter wavelength and a received wavelength of each base station 2. The controller 17 and the BBU controller 18 may be realized by one processor system or by different processor systems.

### Second Embodiment

In the optical transmission system according to the first embodiment, a communication is performed between a host station and a plurality of base stations. Here, it is preferable that, when a failure has occurred in the communication between the host station and the plurality of base stations, a cause of the failure (or a location in which the failure has occurred) be detected. Thus, an optical transmission system according to a second embodiment includes a function that detects a failure in a communication between a host station and a plurality of base stations.

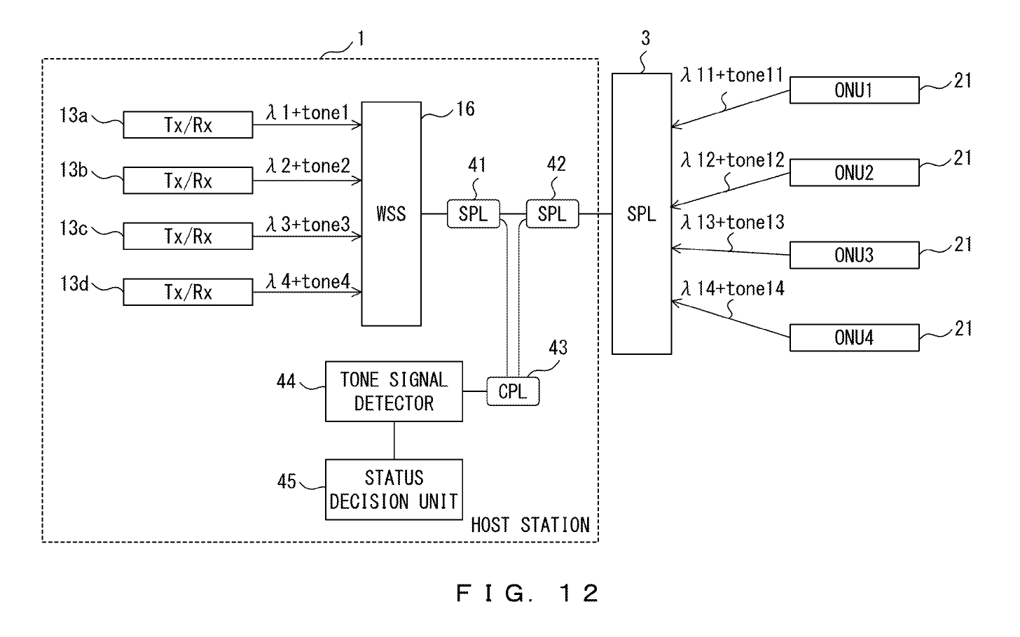

FIG. 12 illustrates an example of a failure detection function that is provided by the optical transmission system according to the second embodiment. The configuration of the optical transmission system is substantially the same in the first and second embodiments. However, in the second embodiment, in order to detect a failure, the host station 1 includes optical splitters 41 and 42, an optical coupler 43, a tone signal detector 44, and a status decision unit 45, as illustrated in FIG. 12. Further, each transceiver 13 (13a-13d) includes a function that superimposes a tone signal on an optical signal to be transmitted. Likewise, each optical network unit 21 (ONU1-ONU4) includes a function that superimposes a tone signal on an optical signal to be transmitted. The tone signal is used as a supervisory signal for detecting a failure.

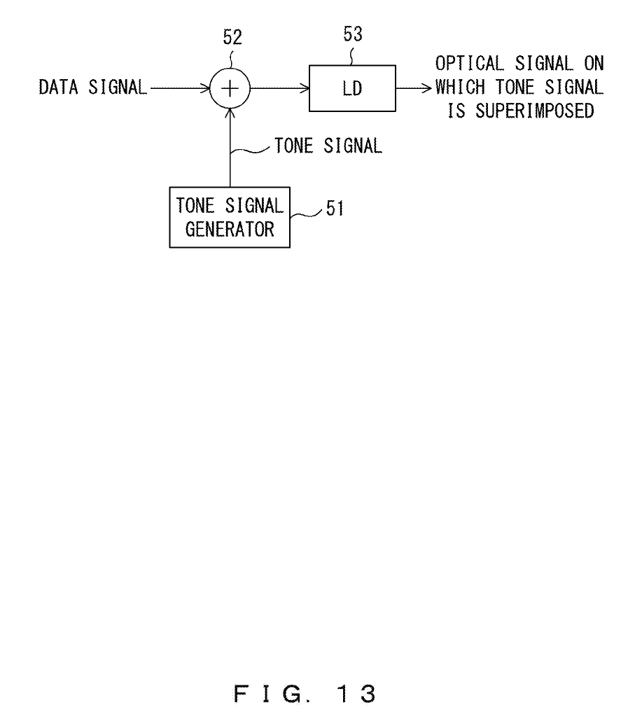

FIG. 13 illustrates an example of a function that superimposes atone signal on an optical signal. In the example of FIG. 13, a tone signal generator 51 generates a tone signal. The tone signal is an oscillation signal of a specified frequency, and may be a sine wave signal. An adder 52 adds a tone signal to a data signal. In the transceiver 13 (13a-13d), the data signal is provided by a corresponding baseband unit 11. In the optical network unit 21 (ONU1-ONU4), the data signal is provided by a corresponding remote radio head 22. A light source 53 is driven by an output signal of the adder 52. In the transceiver 13 (13a-13d), the light source 53 is a wavelength tunable light source. In the optical network unit 21 (ONU1-ONU4), the light source 53 is a wavelength-fixed light source. According to the configuration illustrated in FIG. 13, a modulated optical signal on which a tone signal is superimposed is generated.

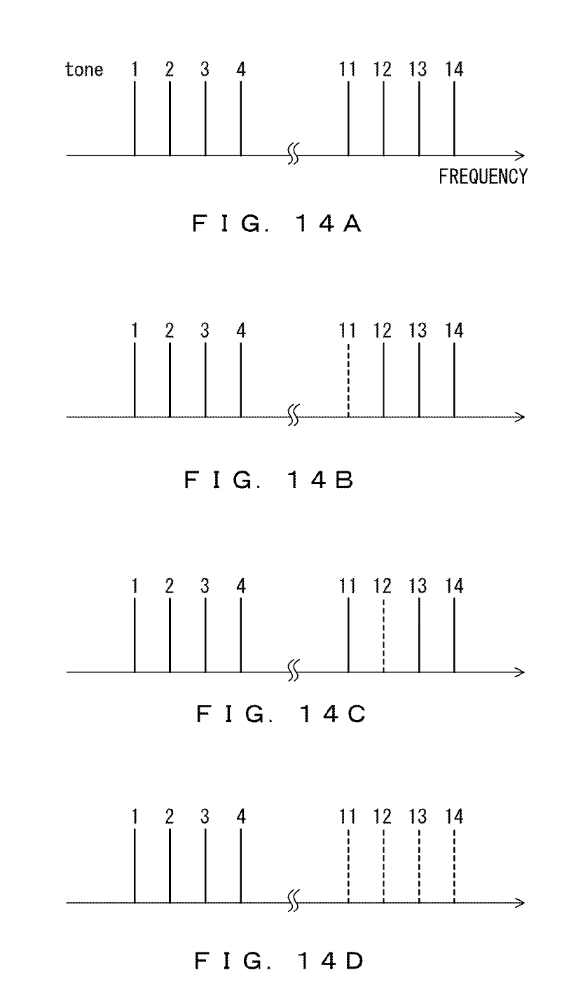

As illustrated in FIG. 14A, the frequencies of tone signals generated by the transceivers 13a-13d and ONU1-ONU4 are different from one another. In this example, the frequencies of tone signals tone1, tone2, tone3, and tone4 generated by the transceiver 13a, the transceiver 13b, the transceiver 13c, and the transceiver 13d are 100 kHz, 110 kHz, 120 kHz, and 130 kHz, respectively. Further, the frequencies of tone signals tone11, tone12, tone13, and tonel4 generated by ONU1, ONU2, ONUS, and ONU4 are 200 kHz, 210 kHz, 220 kHz, and 230 kHz, respectively. In other words, the frequency of a tone signal identifies a device (the transceivers 13a-13d, ONU1-ONU4) that generates a tone signal. As in the case in the first embodiment, the frequencies λ1-λ4 and λ11-λ14 of optical signals generated by the transceivers 13a-13d and ONU1-ONU4 are different from one another.

As described above, in the host station 1, the identification number (P1-P4) of each optical port of the wavelength selective switch 16 and the identification number (tone1-tone4) of a tone signal superimposed on an optical signal received through each of the optical ports are associated with each other. Further, at a base-station side, the location in which each base station is arranged, the transmitter wavelength (λ11-λ14) of each base station, and the identification number (tone11-tonel4) of a tone signal superimposed on an optical signal transmitted from each base station are associated with one another.

The optical splitter 41 splits an optical signal transmitted from the host station 1 to a plurality of base stations 2 and guides the optical signal to the optical coupler 43. The optical splitter 42 splits optical signals transmitted from the respective base stations 2 to the host station 1 and guides the optical signals to the optical coupler 43. The optical coupler 43 guides, to the tone signal detector 44, the optical signal guided from the optical splitter 41 and the optical signals guided from the optical splitter 42.

The tone signal detector 44 includes a photo detector that converts the optical signals guided from the optical coupler 43 into an electric signal. The tone signal detector 44 detects a tone signal from the electric signal generated by the photo detector. For example, the tone signal detector 44 performs an FFT operation on the electric signal generated by the photo detector, so as to obtain a frequency domain signal that indicates a spectrum of a frequency band in which a tone signal is allocated. Then, the status decision unit 45 detects a failure in the optical transmission system according to the frequency domain signal. Note that the status decision unit 45 may decide the status in the optical transmission system according to whether a tone signal superimposed on each optical signal is detected.

An example of a method for detecting a failure in the optical transmission system is described with reference to FIGS. 14A-14D. In this example, the tone signals tonel-tone4 are superimposed on optical signals transmitted from the transceivers 13a-13d, respectively. The tone signals tone11-tonel4 are superimposed on optical signals transmitted from the optical network units 21 (ONU1-ONU4), respectively.

When a failure does not occur in the optical transmission system, all of the tone signals are detected by the tone signal detector 44. Thus, when the spectrum illustrated in FIG. 14A is detected, the status decision unit 45 decides that a failure does not occur in the optical transmission system.

When a branch line between the optical splitter 3 and a base station 2 is broken, a tone signal corresponding to the branch line is not detected. Thus, when the spectrum illustrated in FIG. 14B (a status in which the tone signal tonell does not exist) is detected, the status decision unit 45 decides that the branch line between the optical splitter 3 and ONU1 is broken. Further, when the spectrum illustrated in FIG. 14C (a status in which the tone signal tone12 does not exist) is detected, the status decision unit 45 decides that the branch line between the optical splitter 3 and ONU2 is broken.

When a circuit between the host station 1 and the optical splitter 3 (that is, a transmission link common to ONU1-ONU4) is broken, none of the tone signals tonell-tonel4 are detected. Thus, when the spectrum illustrated in FIG. 14D is detected, the status decision unit 45 decides that the circuit between the host station 1 and the optical splitter 3 is broken.

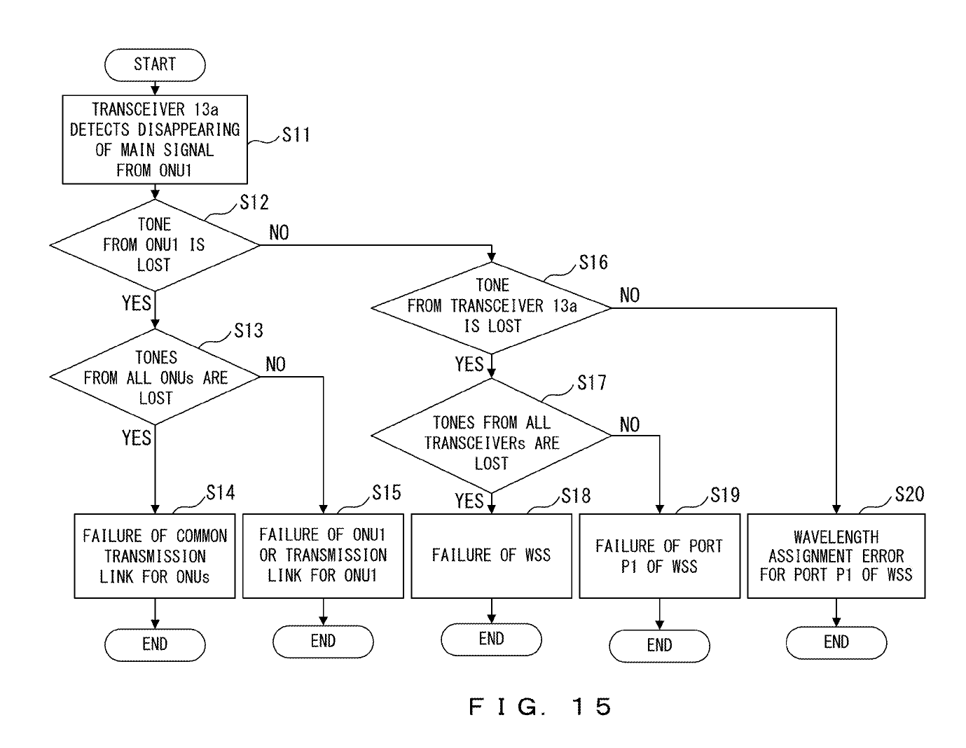

FIG. 15 is a flowchart that illustrates an example of the method for detecting a failure. In the following descriptions, the transceivers 13a-13d and ONU1-ONU4 respectively superimpose tone signals of different frequencies on optical signals, as illustrated in FIG. 12. The transceiver 13a is in communication with ONU1. Then, in S11, the transceiver 13a detects the disappearance of a main data signal transmitted from ONU1. In this case, the transceiver 13a reports, to the status decision unit 45, a message indicating that transceiver 13a does not receive the main data signal.

In S12, the status decision unit 45 decides whether the tone signal of ONU1 is lost according to an output signal of the tone signal detector 44. When the tone signal of ONU1 is lost, the status decision unit 45 confirms, in S13, whether all of the tone signals of ONU1-ONU4 are lost. When all of the tone signals of ONU1-ONU4 are lost, the status decision unit 45 decides that a failure has occurred in a common transmission link between the host station 1 and ONU1-ONU4. On the other hand, when at least one of the tone signals of ONU1-ONU4 is detected, the status decision unit 45 decides, in S15, that ONU1 has broken down or that a failure has occurred in a transmission link between the optical splitter 3 and ONU1.

When there exists the tone signal of ONU1 (S12: No), the status decision unit 45 decides whether the tone signal of the transceiver 13a is lost. When the tone signal of the transceiver 13a is lost, the status decision unit 45 confirms, in S17, whether all of the tone signals of the transceivers 13a-13d are lost. When all of the tone signals of the transceivers 13a-13d are lost, the status decision unit 45 decides, in S18, that the wavelength selective switch 16 has broken down. On the other hand, when at least one of the tone signals of the transceivers 13a-13d is detected, the status decision unit 45 decides, in S19, that an optical port (the port P1 in FIG. 5) of a wavelength selective switch 16 connected to the transceiver 13a has broken down.

When the tone signal of ONU1 is detected and the tone signal of the transceiver 13a is also detected (S16: No), the status decision unit 45 decides, in S20, that the wavelength allocation to an optical port of the wavelength selective switch 16 connected to the transceiver 13a is not correct.

As described above, the status decision unit 45 monitors a tone signal superimposed on each optical signal, so as to identify or estimate a location in which a failure has occurred in an optical transmission system. The failure detection described above may be realized by monitoring a spectrum of a main data signal of each optical channel by use of an OMC (optical channel monitor). However, the OMC is expensive. On the other hand, in the second embodiment, an optical signal is converted into an electric signal by a photo detector such as a photo diode, and a spectrum of the electric signal is monitored, so as to realize a failure detection. In other words, according to the second embodiment, it is possible to realize a failure detection in an inexpensive configuration.

The status decision unit 45 is realized by, for example, a processor system that executes a given program. In this case, the processor system includes a processor element and a memory. This processor system may provide a portion of the function (that is, an FFT operation) of the tone signal detector 44.

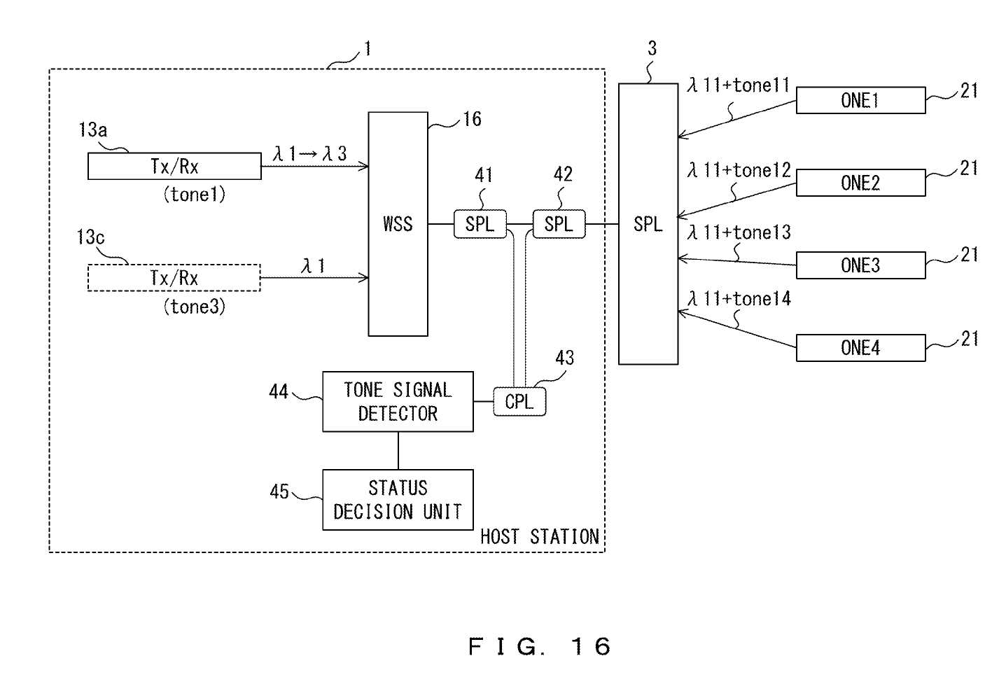

The configuration according to the second embodiment can detect not only a failure in an optical transmission system but also an operational status of the optical line terminal (OLT) 12. A function that detects an operational status of the optical line terminal 12 is described below with reference to FIG. 16.

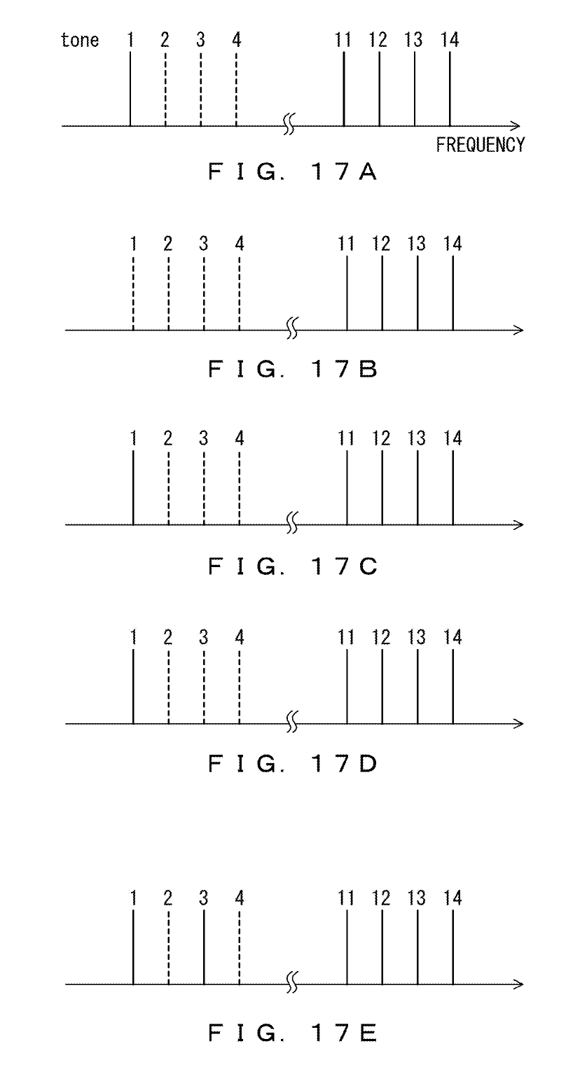

In the example of FIG. 16, the transceiver 13a connected to the optical port P1 of the wavelength selective switch 16 transmits an optical signal of the wavelength λ1. Here, the transceiver 13a superimposes the tone signal tonel on the optical signal. In other words, an optical signal λ1 on which the tone signal tone1 is superimposed is input to the optical port P1 of the wavelength selective switch 16. In this case, the tone signal detector 44 detects the spectrum illustrated in FIG. 17A.

After that, the host station 1 performs a switching operation below:
(1) Change the destination of transmission performed by the transceiver 13a from ONU1 to ONU3.
(2) Start transmitting data to ONU1 using transceiver 13c.

In this case, first, the controller 17 changes the received wavelength at the optical port P1 of the wavelength selective switch 16 from λ1 to λ3 such that the received wavelength at an optical port to which the transceiver 13a is connected is the same as the received wavelength of ONU3. At this point, the transceiver 13a transmits an optical signal of the wavelength λ1. Thus, the optical port P1 of the wavelength selective switch 16 blocks the optical signal transmitted from the transceiver 13a. As a result, when the spectrum illustrated in FIG. 17B is detected by the tone signal detector 44, the status decision unit 45 decides that the setting of the optical port P1 of the wavelength selective switch 16 is correct.

Next, the controller 17 changes the transmitter wavelength of the transceiver 13a from λ1 to λ3 such that the transmitter wavelength of the transceiver 13a is the same as the received wavelength of ONU3. At this point, the received wavelength at the optical port P1 of the wavelength selective switch 16 is λ3. Thus, the wavelength selective switch 16 guides, from the optical port P1 to the optical port P0, an optical signal λ3 transmitted from the transceiver 13a. In this case, the tone signal tone1 superimposed on the optical signal λ3 is detected by the tone signal detector 44. Thus, when the spectrum illustrated in FIG. 17C is detected by the tone signal detector 44, the status decision unit 45 decides that the setting of the transceiver 13a is correct.

Further, the controller 17 sets the received wavelength at the optical port P3 of the wavelength selective switch 16 to λ1, such that the received wavelength at an optical port to which the transceiver 13c is connected is the same as the received wavelength of ONU1. At this point, the transceiver 13c has not transmitted an optical signal yet. Thus, the spectrum illustrated in FIG. 17D is detected by the tone signal detector 44. After that, the controller 17 sets the transmitter wavelength of the transceiver 13c to λ1, such that the transmitter wavelength of the transceiver 13c is the same as the received wavelength of ONU1. At this point, the received wavelength at the optical port P3 of the wavelength selective switch 16 is λ1. Thus, the wavelength selective switch 16 guides, from the optical port P3 to the optical port P0, an optical signal λ1 transmitted from the transceiver 13c. In this case, the tone signal tone3 superimposed on the optical signal λ1 is detected by the tone signal detector 44. Thus, when the spectrum illustrated in FIG. 17E is detected by the tone signal detector 44, the status decision unit 45 decides that the setting of the optical signal P3 of the wavelength selective switch 16 and the setting of the transceiver 13c are correct.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical transmission device that transmits a WDM (wavelength division multiplexed) optical signal to a plurality of remote devices via an optical splitter and receives a plurality of optical signals from the plurality of remote devices via the optical splitter, the optical transmission device comprising:
a plurality of optical transceivers;
a wavelength selective switch; and
a controller configured to control the plurality of optical transceivers and the wavelength selective switch, wherein
each of the optical transceivers includes a wavelength tunable light source,
the controller controls, according to a wavelength of an optical signal received by a destination remote device that is specified from the plurality of remote devices, a wavelength of a wavelength tunable light source of a selected optical transceiver that is selected from the plurality of optical transceivers according to the destination remote device, and
the controller controls the wavelength selective switch so as to generate the WDM optical signal from a plurality of optical signals of different wavelengths generated by the plurality of optical transceivers using respective wavelength tunable light sources, and to guide the plurality of optical signals received from the plurality of remote devices to the plurality of optical transceivers according to wavelengths of the received plurality of optical signals.

2. The optical transmission device according to claim 1, wherein
the controller controls the wavelength selective switch such that a received wavelength at a corresponding optical port of the wavelength selective switch matches the wavelength of an optical signal received by the destination remote device, wherein the selected optical transceiver is connected to the corresponding optical port.

3. The optical transmission device according to claim 2, wherein
the controller controls the wavelength selective switch such that an output wavelength at the corresponding optical port matches the wavelength of an optical signal transmitted by the destination remote device.

4. The optical transmission device according to claim 1, wherein
the wavelength selective switch includes a plurality of wavelength selective switch circuits, and
when two or more remote devices from among the plurality of remote devices perform a coordinated multipoint transmission, two or more optical transceivers that communicate with the two or more remote devices are accommodated in one wavelength selective switch circuit.

5. The optical transmission device according to claim 1, further comprising:
a first optical splitter that is provided between the optical transmission device and the optical splitter and splits the WDM optical signal;
a second optical splitter that is provided between the optical transmission device and the optical splitter and splits the plurality of optical signals transmitted from the plurality of remote devices; and
a status decision unit that decides, according to the WDM optical signal guided from the first optical splitter and the plurality of optical signals guided from the second optical splitter, a status of an optical transmission system that includes the optical transmission device and the plurality of remote devices, wherein
identification signals are respectively superimposed on a plurality of optical signals generated by the plurality of optical transceivers and the plurality of optical signals transmitted from the plurality of remote devices, and
the status decision unit decides the status of the optical transmission system according to whether the identification signal superimposed on each of the optical signals is detected.

6. The optical transmission device according to claim 5, wherein
the status decision unit includes a photo detector that converts the WDM optical signal guided from the first optical splitter and the plurality of optical signals guided from the second optical splitter into an electric signal, and decides the status of the optical transmission system according to the electric signal output from the photo detector.

7. An optical transmission system that includes an optical transmission device, a plurality of remote devices, and an optical splitter provided between the optical transmission device and the plurality of remote devices, wherein
each of the remote devices includes:
a receiver circuit configured to receive an optical signal of a specified wavelength, and
a transmitter circuit configured to transmit an optical signal of a specified wavelength,
wavelengths of optical signals received by the plurality of remote devices are different from one another,
wavelengths of optical signals transmitted by the plurality of remote devices are different from one another,
the optical transmission device includes:
a plurality of optical transceivers,
a wavelength selective switch, and
a controller configured to control the plurality of optical transceivers and the wavelength selective switch,
each of the optical transceivers includes a wavelength tunable light source,
the controller controls, according to a wavelength of an optical signal received by a destination remote device that is specified from the plurality of remote devices, a wavelength of a wavelength tunable light source of an optical transceiver that is selected from the plurality of optical transceivers according to the destination remote device,
the controller controls the wavelength selective switch so as to generate a WDM optical signal from a plurality of optical signals of different wavelengths generated by the plurality of optical transceivers using respective wavelength tunable light sources, and to guide a plurality of optical signals received from the plurality of remote devices to the plurality of optical transceivers according to wavelengths of the received plurality of optical signals, and
the optical splitter guides the generated WDM optical signal to the plurality of remote devices, and guides the received plurality of optical signals to the wavelength selective switch.
